(19) United States
(12) Patent Application Publication
(10) Pub. No.: US 2024/0089102 A1
(43) Pub. Date: Mar. 14, 2024

(54) METHOD FOR PROVIDING FINANCIAL SERVICE THROUGH USER AUTHENTICATION BASED ON IMAGE ID, DEVICE THEREFOR, AND COMPUTER-READABLE RECORDING MEDIUM THEREFOR

(71) Applicant: Kiboum KIM, Seoul (KR)

(72) Inventor: Kiboum KIM, Seoul (KR)

(21) Appl. No.: 17/754,595

(22) PCT Filed: Oct. 12, 2020
(86) PCT No.: PCT/KR2020/013834

§ 371 Date: Apr. 6, 2022

(30) Foreign Application Priority Data
Oct. 14, 2019 (KR) 10-2019-0126581

(51) Int. Cl. H04L 9/32; G06Q 40/00; H04L 9/08

(52) U.S. Cl. CPC H04L 9/32; G06Q 40/00; H04L 9/0861

(57) ABSTRACT

A method for providing a financial service through user authentication based on an image ID is proposed. The method includes: marking identification information, wherein an image to be used as an identity authentication means is received, and the marking of the identification information is performed on one area of the received image; storing an encryption means, wherein user's financial information is encrypted and stored on the received image, a unique key value generated by a server is used, and both are stored in the server; issuing and processing the image ID, wherein the image including the identification information and the encrypted financial information is provided to the user terminal to issue and process the image ID; and providing a financial interface, wherein financial information included in the image ID is decrypted with the unique key value, so as to provide a financial transaction interface to the user terminal.

### TECHNICAL FIELD

The present disclosure relates to a method for providing a financial service through user authentication based on an image ID and, more particularly, to technology that enables a complex authentication procedure required for performing a financial transaction to be simplified by storing identification information and user's financial information for the financial transaction on an image.

### BACKGROUND ART

As smart terminals such as smartphones and tablet PCs become popular, banks are providing smart banking services that enable account customers to receive the banking services by using the smart terminals.

As an example, in Korean Patent Application Publication No. 10-2013-0032452 (FINANCE PORTAL SMART BANKING SERVICE METHOD USING SMART PHONE), technology in which a bank server provides a financial portal smart banking service through smart phones by performing identity authentication based on public certificates is disclosed.

However, in conventional technologies of providing financial services including the aforementioned related art, since remittance may only be carried out when a user who desires to perform the remittance know exact financial information of a remittance target user, it is essential to collect the financial information of the remittance target user before performing a remittance service, and the collected financial information is often input one by one into an input window of an application implementing the remittance service in a user terminal executing the remittance.

That is, in such a conventional method, when there is a plurality of remittance target users, as the amount of financial information to be input by the user who desires to perform the remittance significantly increases, there occurs a problem that the inconvenience of using the remittance service is aggravated. Due to this reason, there is an increasing demand for the development of technology to provide financial services, enabling financial information to be input efficiently.

### DISCLOSURE

### Technical Problem

Accordingly, an objective of the present disclosure is to provide a method for providing a financial service through user authentication based on an image ID, so that the input of financial information may be efficiently performed by identifying the financial information from the image ID issued to a user terminal.

### Technical Solution

According to an exemplary embodiment of the present disclosure to achieve the above objective, there is provided a method for providing a financial service through user authentication based on an image ID, the method being implemented in a computing device configured to include one or more processors and one or more memories to store instructions executable by the processors, and including; marking identification information, wherein an image to be used as an identity authentication means is received when the financial service is used from a user terminal, and the marking of the identification information for identifying that the received image is the image ID is performed on one area of the received image by using an application programming interface (API) linked for the marking of the identification information; storing an encryption means, wherein user's financial information that is input from the user terminal is encrypted and stored on the received image, a unique key value generated by a server is used as an encryption processing means, and the encrypted financial information and the unique key value used as the encryption means are stored in the server; issuing and processing the image ID, wherein the image including the identification information and the encrypted financial information is provided to the user terminal, so as to issue and process the image ID of a user; and providing a financial interface, wherein financial information included in the image ID selected as a financial transaction target in the user terminal is decrypted with the unique key value after an execution command of an application related to financial service provision is received from the user terminal, so as to provide a financial transaction interface corresponding to the decrypted financial information to the user terminal.

Preferably, when performing the providing of the financial interface described above, the server may perform verification of the identification information marked on the image ID selected and input in the user terminal, so as to determine whether to grant access to the financial information included in the image ID.

Preferably, the unique key value described above may be automatically generated from the server as a value to include at least any one of a special character, a number, and letter, and may be used as a means for authenticating and identifying one or more image IDs by allowing different unique key values to be assigned to the respective image IDs.

Preferably, after performing the issuing and processing of the image ID described above, in the server, the image ID issued to the user terminal and the unique key value used for the image ID may be stored and managed in correspondence with each other.

Preferably, the financial information described above may be inserted and stored in the one area of the image, and may be inserted and stored in a form identifiable only by a preset processor configured to extract the financial information from the image by controlling the encrypted financial information and format information including at least any one of a size, transparency, and a color of the unique key value.

Preferably, the financial information described above may be inserted and stored in the one area of the image, and may be inserted and stored in a form of link information capable of receiving the encrypted financial information and the unique key value in the one area of the image.

Preferably, information including at least any one of the user's financial information and the unique key value may be cached in a file constituting the image described above, and the information including at least any one of the user's financial information and the unique key value may be stored in a form of a data stream in the file constituting the image.

Preferably, the financial transaction interface described above may provide a query service for financial information stored in a first image ID when the first image ID that is the image ID issued to the user terminal is selected from the user terminal, and may provide a remittance service for financial information stored in a second image ID when the second image ID issued to a second user terminal is selected from the user terminal.

Preferably, when the second image ID is selected through the financial transaction interface in the user terminal described above, the financial information decrypted from the second image ID to the user terminal may be financial information on a depositor name, a bank name, and an account number.

Preferably, after performing the issuing and processing of the image ID described above, the user terminal may be provided with the financial transaction interface corresponding to the image ID when there is selection and input for the image issued and processed as the image ID of the user from the user terminal.

Meanwhile, there is provided a device for providing a financial service through user authentication based on an image ID, the device being implemented in a computing device configured to include one or more processors and one or more memories to store instructions executable by the processors, and including; an identification information marking part, wherein an image to be used as an identity authentication means is received when the financial service is used from a user terminal, and marking of identification information for identifying that the received image is the image ID is performed on one area of the received image by using an application programming interface (API) linked for the marking of the identification information; an encryption means storing part, wherein user's financial information that is input from the user terminal is encrypted and stored on the received image, a unique key value generated by a server is used as an encryption processing means, and the encrypted financial information and the unique key value used as the encryption means are stored in the server; an image ID issuing and processing part, wherein the image including the identification information and the encrypted financial information is provided to the user terminal, so as to issue and process the image ID of a user; and a financial interface providing part, wherein financial information included in the image ID selected as a financial transaction target in the user terminal is decrypted with the unique key value after an execution command of an application related to financial service provision is received from the user terminal, so as to provide a financial transaction interface corresponding to the decrypted financial information to the user terminal.

Meanwhile, there is provided a computer-readable recording medium described above, including: a plurality of instructions stored therein and configured to allow a computing device to perform steps as below, wherein the steps described above include: marking identification information, wherein an image to be used as an identity authentication means is received when the financial service is used from a user terminal, and the marking of the identification information for identifying that the received image is the image ID is performed on one area of the received image by using an application programming interface (API) linked for the marking of the identification information; storing an encryption means, wherein a user's financial information that is input from the user terminal is encrypted and stored on the received image, a unique key value generated by a server is used as an encryption processing means, and the encrypted financial information and the unique key value used as the encryption means are stored in the server; issuing and processing the image ID, wherein the image including the identification information and the encrypted financial information is provided to the user terminal, so as to issue and process the image ID of a user; and providing a financial interface, wherein financial information included in the image ID selected as a financial transaction target in the user terminal is decrypted with the unique key value after an execution command of an application related to financial service provision is received from the user terminal, so as to provide a financial transaction interface corresponding to the decrypted financial information to the user terminal.

### Advantageous Effects

According to an exemplary embodiment of the present disclosure, identification information and user's financial information is stored on an image received from a user terminal so that an image ID is issued, and when performing financial transactions, the image ID issued to the user terminal is used as an identity authentication means, whereby there is an effect that the simplification of an authentication system for financial transactions may be promoted.

In addition, according to the exemplary embodiment of the present disclosure, the financial information including user's personal information is encrypted with a unique key value stored only in a server, and then is issued and processed as the image ID, whereby there is an effect of preventing damage caused by leakage of the user's personal information.

In addition, according to the exemplary embodiment of the present disclosure, through authentication of the image ID, a user may easily inquire about his/her own financial information, as well as easily perform remittance to another user's financial account, whereby there is an effect of maximally increasing the convenience of mobile financial services.

In addition, according to the exemplary embodiment of the present disclosure, financial information including user's personal information is inserted and stored in an image ID in an unidentifiable way and the image ID is encrypted and stored as a unique key value, whereby there is an effect of being able to manage and protect the user's personal information at a high security level.

### DESCRIPTION OF DRAWINGS

FIG. 1 is a flowchart of a method for providing a financial service through user authentication based on an image ID according to an exemplary embodiment of the present disclosure.

FIG. 2 is a view illustrating an example of realizing an image ID by marking identification information in an image, and by inserting and storing financial information in the image according to the exemplary embodiment of the present disclosure.

FIG. 3 is a view illustrating an example in which financial information is stored in a data stream of an image file according to the exemplary embodiment of the present disclosure.

FIG. 4 is a view illustrating an example in which a user's financial information query service is provided through a financial transaction interface according to the exemplary embodiment of the present disclosure.

FIG. 5 is a view illustrating an example in which a remittance service is provided through the financial transaction interface according to the exemplary embodiment of the present disclosure.

FIG. 6 is a block diagram illustrating a structure of the image ID according to the exemplary embodiment of the present disclosure.

FIG. 7 is a block diagram illustrating a device for providing a financial service through user authentication based on an image ID according to the exemplary embodiment of the present disclosure.

FIG. 8 is a view illustrating an example of an internal configuration of a computing device according to the exemplary embodiment of the present disclosure.

### BEST MODE

Hereinafter, various exemplary embodiments and/or aspects are disclosed with reference to the drawings. In the following description, for the purpose of explanation, numerous specific details are disclosed to provide a thorough understanding of one or more aspects. However, it will also be recognized by those skilled in the art that such aspect(s) may be practiced without these specific details. The following description and accompanying drawings particularly describe in detail exemplary aspects of one or more aspects. However, such aspects are illustrative, and some of various methods in principles of various aspects may be used, and the descriptions set forth are intended to include all such aspects and their equivalents.

In “exemplary embodiment”, “example”, “aspect”, “illustration”, etc. used in the present specification, it may not be construed that any aspect or design described herein are better than or more advantageous than other aspects or designs.

In addition, terms “comprises” and “includes”, and/or “comprising” and “including” mean that a corresponding feature and/or component is present, but it should be understood that the presence or additions of one or more other features, components and/or groups thereof are not excluded from the terms.

In addition, it will be understood that, although the terms including ordinal numbers, such as first, second, etc. may be used herein to describe various components, these components should not be limited by these terms. These terms are only used for the purpose of distinguishing one component from another component. For example, without departing from the scope of the present disclosure, a first component may be referred to as a second component, and similarly, the second component may be referred to as the first component. The term “and/or” includes a combination of a plurality of related stated items or any of the plurality of related stated items.

In addition, unless otherwise defined, all terms including technical and scientific terms used herein have the same meaning as commonly understood by one of those skilled in the art to which the present disclosure belongs. It will be further understood that terms as defined in dictionaries commonly used herein should be interpreted as having a meaning that is consistent with their meaning in the context of the related art and will not be interpreted in an idealized or overly formal sense unless expressly so defined in the exemplary embodiment of the present disclosure.

The present disclosure relates to a method for providing a financial service through user authentication based on an image ID, wherein a complex authentication procedure required for performing a financial transaction is allowed to be simplified by storing identification information and user's financial information for the financial transaction on an image. An objective of the present disclosure is to provide the method for providing the financial service through the user authentication based on the image ID, so that inputting of the user's financial information may be efficiently performed by identifying the user's financial information from the image ID issued to a user terminal.

Hereinafter, the present disclosure for achieving the above objective will be described in more detail with reference to the accompanying drawings.

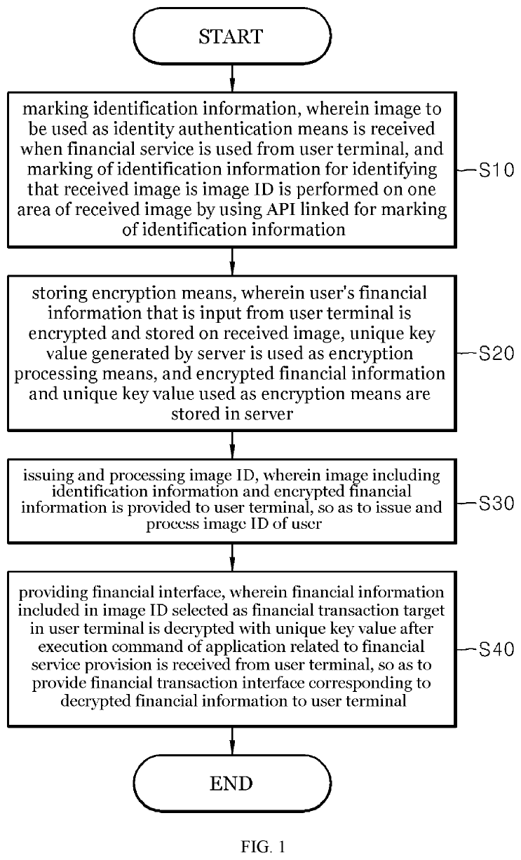

Accordingly, referring to FIG. 1, a flow chart of the method for providing the financial service through the user authentication based on the image ID is illustrated in FIG. 1, the method being realized in a computing device including one or more processors and one or more memories for storing instructions executable by the processor.

As shown in FIG. 1, first, step S10 of marking identification information may be performed, wherein an image to be used as an identity authentication means is received from a user terminal when using a financial service, and an API linked for the marking of the identification information is used in one area of the received image so that the marking of the identification information for identifying that the image received from the user terminal is the image ID is performed.

In this case, when the image received from the user terminal is in a form of an image file, various images such as a user's face image, a logo image, and an illustration image may be used.

In addition, the above-described application programming interface (API) may be understood as an API linked for identification information marking in the one area of the image file received from the user terminal.

In addition, the above-described identification information may be understood to be marked on the one area of the image in a form including at least any one of a preset logo and text, and in this case, the identification information may be marked in a form that may be identified with the naked eye. However, the identification information may be marked in a form that may not be identified with the naked eye, and the present disclosure is not limited thereto.

Meanwhile, it is to be understood that the above-described identification information marked on the image by performing step S10 described above is used as a means for determining, as the image ID, the image marked with the identification information among one or more images in an application related to the provision of financial services.

Meanwhile, in the present disclosure, after step S10 described above is performed, step S20 of encrypting and storing information may be performed, wherein the user's financial information that is input from the user terminal is stored on the image, and the financial information stored on the image is encrypted and stored by using a unique key value generated from a server.

In this case, the above-described financial information is financial information including at least any one of a bank name, an account number, and a depositor name. In other words, it may be understood that the information linked with a bank account is stored on the above-described image, and the financial information inserted and stored on the image may have various storage types.

As a first exemplary embodiment, the above-described financial information is inserted and stored in one area of the image received from the user terminal, and the above-described financial information may be allowed to be inserted and stored in a form identifiable only by a preset processor configured to extract the financial information from the image by controlling the encrypted financial information and format information including at least any one of a size, transparency, and a color of the unique key value.

To describe with a more specific example, the above-described financial information may be inserted and stored with a font size unable to be identified with the naked eye on the image received from the user terminal but identifiable by the processor, or the color of the inserted financial information may be made transparent, or the financial information is stored in the same color as the image color of the area into which the financial information is inserted, so that the user's financial information included in the image may be inserted and stored not to be identified by others.

Meanwhile, in a second exemplary embodiment, the above-described financial information may be inserted and stored in one area of an image, and may be inserted and stored in a form of link information through which the financial information may be received in the one area of the image.

In other words, the above-described second exemplary embodiment may be understood as a means for indirectly inserting and storing the financial information in the above-described image by providing the user's financial information through a link connection.

That is, according to the above-described first and second exemplary embodiments, in the image received to be used as the image ID from the user terminal, the financial information may be inserted and stored in a form unable to be identified by other people.

Meanwhile, in this case, in step S20 described above, it is preferable to encrypt and store the financial information, in order to strengthen the protection of the financial information including personal information.

Specifically, the above-described encryption means may use the unique key value generated from the server. In this case, the above-described unique key value may be understood as a value being automatically generated to include at least any one of a special character, a number, and letter. In addition, conceptually, the above-described unique key value may be understood as a means used for authenticating and identifying one or more image IDs by providing different unique key values for respective image IDs.

Meanwhile, it may be understood that the above-described unique key value is automatically generated by the server, and unique key values corresponding to respective image IDs are transmitted to the server, so as to be stored and managed by the server, thereby being used as a means for processing encryption and decryption of the financial information.

Specifically, when a request for performing a financial transaction including a remittance service is input by using an image ID from a user terminal, the server compares a first unique key value that is a unique key value included in an image used as the image ID and a second unique key value stored on the server for the above-described image ID, so as to determine whether the first unique key value and the second unique key value are identical to each other, thereby determining the validity of the image ID.

In this case, the server determines a case in which the first unique key value and the second unique key value match each other as normal access, so that an interface related to the financial transaction service is provided by decrypting the financial information included in the above-described image ID. Whereas, the server determines a case in which the first unique key value and the second unique key value does not match each other as abnormal access, so as not to perform decryption of the financial information included in the above-described image ID, thereby functioning to block the access to the financial information.

That is, in the present disclosure, by performing the above-described step S20, financial information including user's personal information is inserted and stored in an image ID in an unidentifiable way and the image ID is encrypted and stored as a unique key value, whereby there is an effect of being able to manage and protect the user's personal information at a high security level.

Meanwhile, in the present disclosure, after performing step S20 described above, step S30 of issuing and processing an image ID may be performed, wherein the image including the identification information and the encrypted financial information is provided to the user terminal so as to issue and process the image ID of a user.

That is, step S30 may be understood as a step in which the image including the identification information and the financial information encrypted with the unique key value is provided to the user terminal by steps S10 and S20 above, so as to issue and process the image ID that is an identity authentication means when using a financial service.

In this case, it may be understood that the above-described image ID is issued and processed for each piece of financial information included in the image, so that one or more image IDs may be issued and processed in the user terminal. When a plurality of image IDs is issued and processed, it is preferable to use different images for respective image IDs, so that the financial information included in each image ID may be identifiable by the user.

Meanwhile, as another exemplary embodiment of the present disclosure, after performing step S30 described above, when there is selection and input for the image issued and processed as the image ID from the user terminal, a financial transaction interface corresponding to the image ID may be provided to the user terminal.

As an example, it may be understood that, when there is selection and input for an image stored in a gallery of the user terminal, an application related to the financial service provision may be allowed to be executed automatically. Accordingly, there is an effect of increasing the user's convenience in using the financial service.

Meanwhile, in the present disclosure, after performing step S30 described above, it is preferable that the image ID issued to the user terminal and the unique key value generated in the image ID are transmitted to the server, so as to correspond the user's image ID and the unique key value for decrypting the image ID with each other and store and manage the user's image ID and the unique key value in the server, thereby functioning to decrypt the encrypted financial information included in the image ID and provide the decrypted financial information from the server side to the user terminal side.

Meanwhile, after issuing and processing the image ID described above and storing the same in the server and then receiving an execution instruction of the application related to the financial service provision from the user terminal, the financial information included in the image ID selected as a financial transaction target in the user terminal is decrypted to the unique key value, so that step S40 of providing a financial transaction interface may be performed, wherein the financial transaction interface corresponding to the decrypted financial information is provided to the user terminal.

Specifically, when performing step S40, the server verifies whether the identification information marked on the image ID selected and input from the user terminal is the identification information previously performed in step S10, and according to the result of the verification, the server may determine whether to grant access to the financial information included in the image ID.

That is, it may be understood that the server grants access to the financial information when the identification information marked on the image matches, and restricts the access to the financial information when the identification information marked on the image does not match.

Meanwhile, when the identification information inserted in the image ID matches and the access to the financial information is granted, the server may provide a financial transaction interface corresponding to the decrypted financial information by loading the unique key value for decrypting the financial information included in the image ID.

As an exemplary embodiment, the above-described financial transaction interface may provide services for various financial transactions, and as an example, may provide a query service for financial information stored in a first image ID when the first image ID, which is the image ID issued to the user terminal, is selected from the user terminal.

Specifically, by decrypting the financial information of the first image ID into the unique key value, the above-described query service may provide the query service of financial information including at least any one of an account balance, deposit and withdrawal history, account number information, and opening information, which are included in the first image ID.

That is, accordingly, contrary to the fact that for inquiring about financial information, users have to perform a complex procedure, such as entering a dedicated bank ID and password by running a conventional bank application, or entering a password for an issued public certificate, there is an effect that the users may easily inquire about their financial information with a significantly simplified procedure.

Meanwhile, the above-described financial transaction interface may also provide a remittance service for financial information stored in a second image ID when the second image ID issued to a second user terminal is selected from the user terminal.

Similarly, the encrypted financial information included in the above-described second image ID may be decrypted by the unique key value stored in the server. In this case, the information to be decrypted from the second image ID to the user terminal is the minimal financial information for performing the remittance service, and thus it is preferable to ensure that leakage of extremely personal financial information of other people unnecessary for performing the remittance is blocked beforehand by decrypting only the financial information on a depositor name, a bank name, and an account number.

Meanwhile, in the present disclosure, just with act of selecting a second image ID so as to input an amount to be remitted and performing selection and input for a first image ID of a user himself/herself to be a subject of withdrawal, the remittance amount may be easily transferred to another person's financial account linked to the second image ID.

In addition, further to this, when performing a remittance service in the related art, remittance is possible only when an account number of another person is clearly known. However, in the present disclosure, since a second image ID includes financial information of a second user, there is an effect that the remittance service may be provided by easily extracting account number information, a bank name, and depositor information, which are required for the remittance, from among the financial information of the second user just with the act of selecting a second image ID.

Meanwhile, in another exemplary embodiment of the present disclosure, when performing a remittance service to a financial account of a second user linked to a second image ID through a financial transaction interface, financial information decrypted from the second image ID to a user terminal may be processed to have a differentiated format in the user terminal, so as to be displayed on a screen.

That is, it may be understood that in order to use as a means for preventing a user's remittance mistake, the above-described exemplary embodiment changes a format of at least any one of a font, a size, and a color of financial information corresponding to the depositor name, the bank name, and the account number, which are the second user's financial information decrypted from the second image ID, so as to output the format of the financial information to the user terminal.

Comprehensively, according to the exemplary embodiment of the present disclosure, identification information and user's financial information is stored on an image received from a user terminal to issue an image ID, and when performing a financial transaction, the image ID issued to the user terminal is used as an identity authentication means, whereby there is an effect of promoting the simplification of the authentication system for financial transactions.

In addition, according to the exemplary embodiment of the present disclosure, the financial information including user's personal information is encrypted with a unique key value stored only in a server and then issued and processed as the image ID, and thus there is an effect of preventing damage caused by the leakage of the user's personal information.

In addition, according to the exemplary embodiment of the present disclosure, through image ID authentication, a user may easily inquire about his/her own financial information, as well as easily perform remittance to another user's financial account, whereby there is an effect of maximally increasing the convenience of the mobile financial services.

In addition, according to the exemplary embodiment of the present disclosure, financial information including user's personal information is inserted and stored in an image ID in an unidentifiable way and the image ID is encrypted and stored as a unique key value, whereby there is an effect of being able to manage and protect the user's personal information at a high security level

As described above, although the exemplary embodiments have been described with reference to the limited exemplary embodiments and drawings, various modifications and variations are possible from the above description by those skilled in the art.

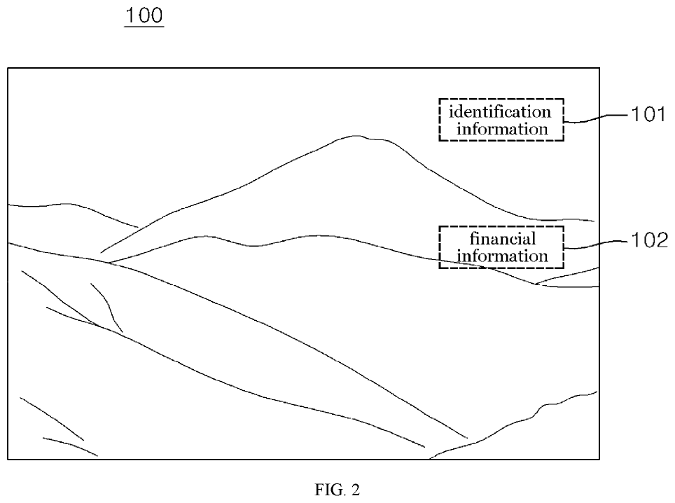

FIG. 2 is a view illustrating an example of realizing an image ID by marking identification information in an image, and by inserting and storing financial information in the image according to the exemplary embodiment of the present disclosure. In the description below, descriptions of unnecessary exemplary embodiments that overlap those of FIG. 1 will be omitted.

Accordingly, an example of receiving an image to be used as an image ID in a user terminal is illustrated on a screen 100 of FIG. 2, and as described previously, identification information 101 for identifying an image ID and financial information 102 input by linking with the user terminal may be inserted and stored in the image received in this way.

In this case, it may be understood that the above-described identification information 101 may be marked on an image in a form including at least any one of a logo and text, and the above-described financial information 102 may have information including at least any one of a depositor name, a bank name, and an account number, which are encrypted with a unique key value generated by a server and inserted and stored in the server.

In this case, it is preferable to understand that, in order to prevent other people from easily identifying the image ID, the above-described identification information 101 and financial information 102 is inserted and stored in a form that makes identification with the naked eye impossible.

That is, as shown in a screen 100 of FIG. 2, the embodiment of the present disclosure provides the image ID including the identification information 101 and the financial information 102 as an identity authentication means, so the financial service may be provided through user authentication based on the image ID in a new form in which the authentication process is significantly simplified, compared with a financial service performed through entering a conventional public certificate or entering ID and password.

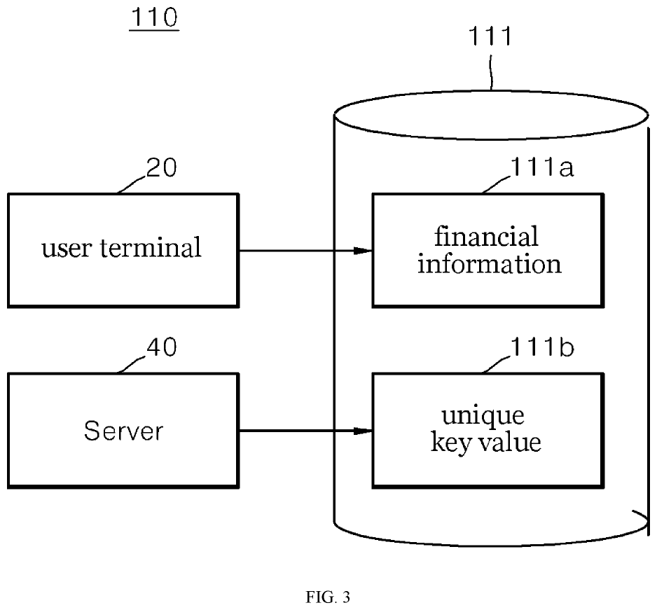

Meanwhile, in another exemplary embodiment of the present disclosure, the above-described financial information may be stored in a file constituting an image in the form of a data stream, and FIG. 3 will be referred to for a more detailed description thereof.

As shown in a view 110 in FIG. 3, information including at least any one of user's financial information 111a input from a user terminal 20 and a unique key value information 111b generated by a server 40 is cached in an image file 111 constituting an image, so that the user's financial information 111a and the unique key value information 111b may be stored in the image file 111 in the form of a data stream.

In this case, it is natural that the above-described user's financial information 111a is encrypted with the above-described unique key value. Whenever a financial transaction service using an image ID is executed in the user terminal, a processor transmits, to the server 40, information including at least any one of the user's financial information 111a and unique key value information 111b, which is cached in the image file, and analyzes whether the information and the unique key value stored in the server 40 match, so as to determine the validity of the image ID.

That is, accordingly, the embodiment of the present disclosure has an effect of providing a financial service that implements an efficient data processing method while managing the protection of sensitive user's personal financial information at a high security level.

As described above, although the exemplary embodiments have been described with reference to the limited exemplary embodiments and drawings, various modifications and variations are possible from the above description by those skilled in the art.

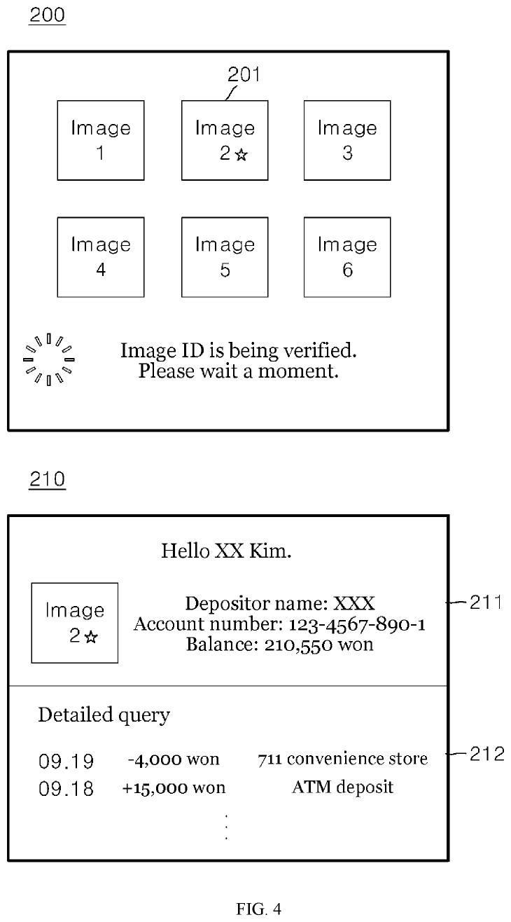

FIG. 4 is a view illustrating an example in which a user's financial information query service is provided through a financial transaction interface according to the exemplary embodiment of the present disclosure.

In the description below, descriptions of unnecessary exemplary embodiments that overlap those of FIGS. 1 to 3 and descriptions of unnecessarily overlapped exemplary embodiments will be omitted.

First, on a screen 200 of FIG. 4, an example in which verification of an image ID is performed after receiving an execution instruction of the application related to financial service provision is illustrated.

Specifically, in the present disclosure, when an execution instruction of the application is received, each of a plurality of images including a previously issued image ID 201 is displayed on the user terminal, so that an image used as the image ID 201 is selected from the user terminal and whether the selected image is the image ID 201 or not is verified.

As a result of the verification, when it is determined that the selected image is the image ID 201 because identification information exists in the image selected by the user terminal, the server may provide a financial transaction interface to the user terminal by decrypting the encrypted financial information included in the image ID 201 with a pre-stored unique key value.

Meanwhile, on a screen 210 of FIG. 4, an exemplary embodiment in which financial information included in the image ID 201 selected in the user terminal is decrypted and a financial information query service is provided to the user terminal is illustrated. In this case, the above-described financial information query service may provide the account information 211, including information on an account number and a balance, and deposit and withdrawal history information 212, as the financial information stored in the image ID 201.

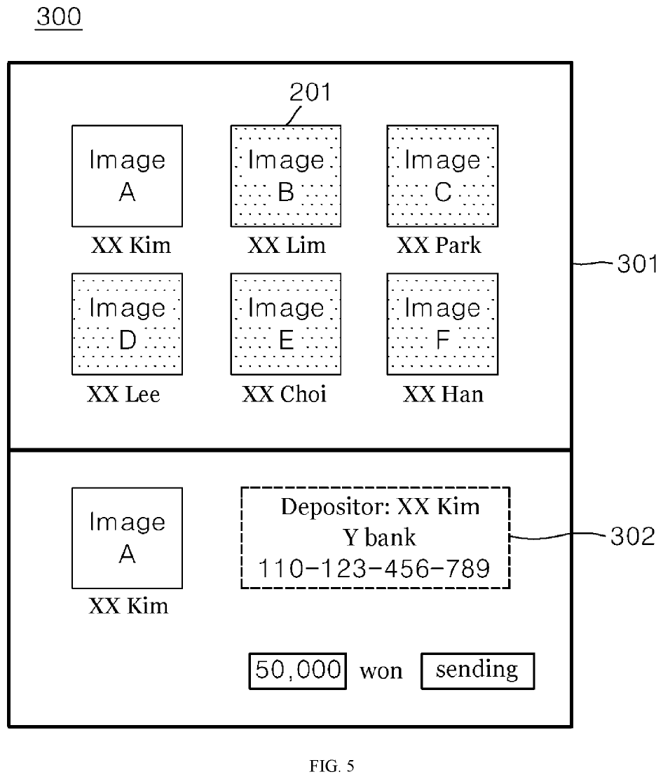

Meanwhile, in another exemplary embodiment of the present disclosure, when information on selection and input for a second image ID issued to a second user terminal using an application related to financial service provision is received from a user terminal after verification of an image ID is completed, a remittance service may be provided through a financial transaction interface of the present disclosure, and a specific exemplary embodiment of this case is illustrated on a screen 300 in FIG. 5.

As illustrated in the screen 300, a second image ID list 301 issued to the second user terminal as a second user list capable of performing remittance through the financial transaction interface is output to a user terminal, whereby an amount corresponding to an input remittance amount may be remitted to a financial account side included in a second image ID selected from the user terminal.

In this case, it may be understood that the second image ID list 301 that is output to the user terminal is a list in which image IDs of users having an image ID issuance history are output through the application related to the provision of the financial service linked with a phone book stored in the user terminal. Accordingly, in the present disclosure, a remittance service may be able to be performed through the second image ID as a means.

Meanwhile, the remittance service through the second image ID as the means is performed when there is selection and input for the second image ID in the user terminal, and the server decrypts the encrypted financial information included in the second image ID selected in the user terminal with the unique key value, so as to provide the minimal amount of financial information of the second user required for the remittance to the user terminal side.

In this case, in the present disclosure, it may be preferable that when an image ID (i.e., a second image ID) issued to another user terminal is selected other than the image ID issued to the user terminal, only information on a depositor name, a bank name, and an account number, which are displayed in an image 302, is provided to the user terminal as information for performing a remittance service, so as to block the leakage of unnecessary personal information other than the information essential for performing the remittance service while functioning to enable the remittance service to be performed, whereby there is an effect of managing and protecting personal information at a high security level.

Meanwhile, in a more preferred exemplary embodiment of the present disclosure in providing the remittance service described above, it is preferable to apply a differentiated format to prevent a remittance mistake when information on the depositor name, the bank name, and the account number, which are the financial information extracted from the second image ID, is output to the user terminal.

That is, as illustrated in the screen 300, visibility may be improved by changing the font of information corresponding to the financial information, extracted from the second image ID, among various pieces of information output through the financial transaction interface.

In this case, although not specifically shown on the screen 300, the visibility is further improved by applying an animation effect to the financial information extracted from the above-described second image ID, so that the information on a remittance target user may be more clearly recognized by the user performing the remittance, and the present disclosure is not limited thereto.

As described above, although the exemplary embodiments have been described with reference to the limited exemplary embodiments and drawings, various modifications and variations are possible from the above description by those skilled in the art.

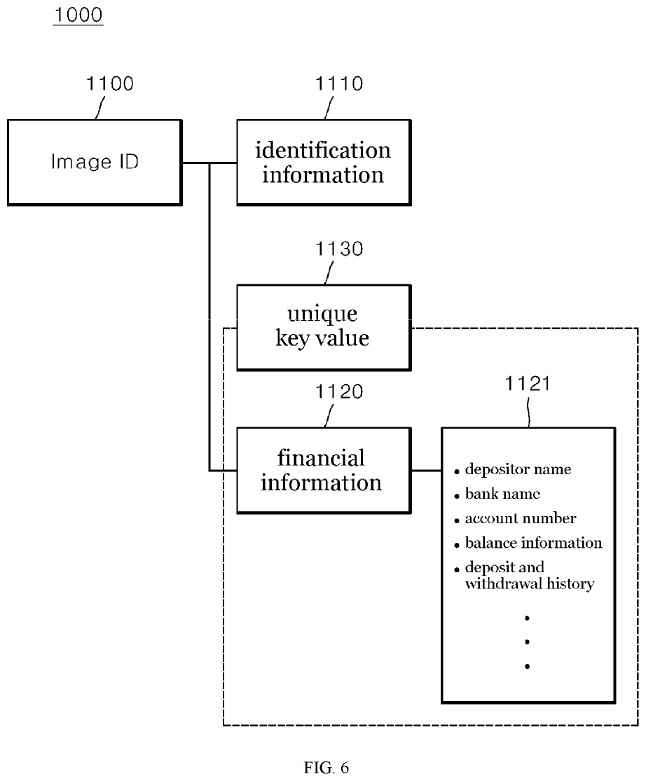

FIG. 6 is a block diagram illustrating the structure of an image ID according to the exemplary embodiment of the present disclosure. In the description below, descriptions of unnecessary exemplary embodiments that overlap with those of FIGS. 1 to 5 will be omitted.

Referring to a view 1000 in FIG. 6, an image ID is allowed to include identification information and financial information, so that the image ID issued to a user terminal is used as an identity authentication means when performing a financial transaction, thereby promoting the simplification of the authentication system for financial transactions.

Specifically, the identification information described above has a form including at least any one of a logo and text, and conceptually, may be understood as a means for identifying an image ID when the application related to the financial service provision is executed by marking preset identification information on an image.

In addition, the financial information described above may be understood as information, obtained from the user terminal, including at least any one of the depositor name, the bank name, the account number, the balance, and the deposit and withdrawal history. When the above-described financial information is leaked to the outside, there is a high risk of being misused, and thus it may be understood that the financial information is encrypted with a unique key value, and inserted and stored in the image ID.

That is, the image ID may be understood to include the identification information and the financial information encrypted with the unique key value. In this case, the above-described unique key value is transmitted to, and stored and managed in the server together with the image ID issued to the user terminal, and accordingly, just with the act of selecting the image ID on the user terminal, decryption is performed with the unique key value corresponding to the image ID selected in the server, whereby a financial transaction interface may be provided.

In other words, since a separate authentication procedure such as password input for decrypting the encrypted financial information is not required on the user side, the present disclosure has an effect that the simplification of the authentication system for financial transactions is promoted and the convenience of financial information queries and remittance services is increased.

As described above, although the exemplary embodiments have been described with reference to the limited exemplary embodiments and drawings, various modifications and variations are possible from the above description by those skilled in the art.

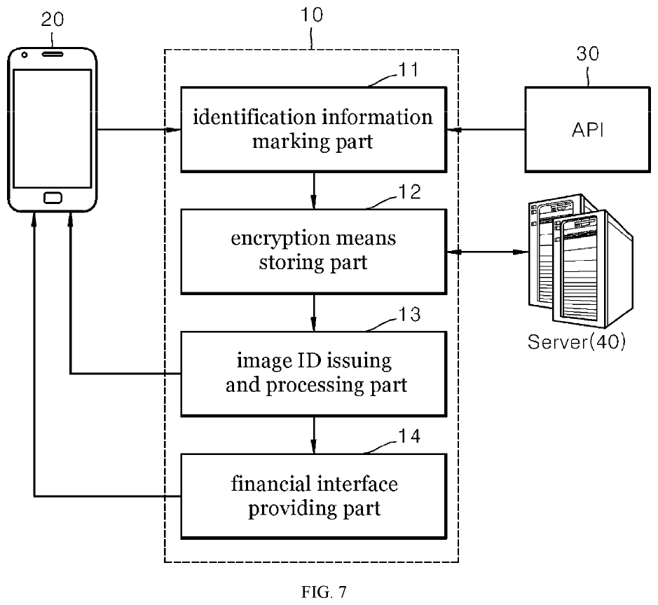

Meanwhile, FIG. 7 illustrates a block diagram of a device 10 of providing a financial service through user authentication based on an image ID implemented by a computing device including one or more processors and one or more memories for storing instructions executable by the processor according to the exemplary embodiment of the present disclosure.

In this case, in the description of FIG. 7 described above, descriptions of unnecessary exemplary embodiments that overlap with those of FIGS. 1 to 6 will be omitted.

As shown in FIG. 7, the device 10 of providing the financial service through the user authentication based on the image ID of the present disclosure may include an identification information marking part 11, an encryption means storing part 12, an image ID issuing and processing part 13, and a financial interface providing part 14.

Specifically, the identification information marking part 11 is configured to receive, from a user terminal 20, an image to be used as an identity authentication means when using a financial service, and perform marking of identification information for identifying that the received image is an image ID by using an API 30 linked to mark the identification information on one area of the received image.

Specifically, the identification information marking part 11 performs the marking of the identification information in the form including at least any one of a logo and text on the one area of the received image, so as to check whether the identification information marked on the image among a plurality of images exists or not, thereby performing verification such as granting of access in the application related to the financial service provision.

That is, the above-described identification information marking part 11 may preferably be understood to be capable of performing all the functions performed in step S10 in FIG. 1 described above.

Meanwhile, the above-described encryption means storing part 12 is configured to store user's financial information, which is input from a user terminal 20, on an image, and perform a function of encrypting and storing the financial information stored on the image by using a unique key value generated from the server 40.

Specifically, in order to store the financial information inserted and stored in the image in the format unable to be identified by others, the encryption means storing part 12 is configured to change the format of the financial information or insert and store the financial information in the form of a link to receive the financial information, and encrypt the financial information with the unique key value automatically generated by the server 40 and store the same, thereby performing a function of preventing the leakage of the user's personal information included in the financial information.

That is, it is preferable that the above-described encryption means storing part 12 is understood to be capable of performing all the functions performed in step S20 in FIG. 1.

Meanwhile, the image ID issuing and processing part 13 described above is configured to perform a function of issuing and processing an image ID of a user by providing an image including identification information and encrypted financial information to the user terminal 20.

That is, by providing, to the user terminal 20, as the image ID, an image configured to be received from the user terminal 20 and include the identification information and the encrypted financial information, which are inserted by previously performing the functions of the identification information marking part 11 and the encryption storing part 12, the image ID issuing and processing part 13 performs a function of issuing and processing the image ID to be used as a personal authentication means when using a financial service. As a result, it may be understood that the above-described image ID issuing and processing part 13 may be capable of performing all the functions performed in step S30 in FIG. 1 described above.

Meanwhile, a financial transaction interface providing part 14 described above is configured to decrypt the financial information included in the image ID selected as a financial transaction target in the user terminal 20 with a unique key value after receiving an execution instruction of the application related to the financial service provision from the user terminal 20, so as to perform a function of providing a financial transaction interface corresponding to the decrypted financial information to the user terminal 20.

Specifically, the financial transaction interface providing part 14 verifies the identification information included in the image ID, grants access to the financial information included in the image ID according to a result of the verification, and decrypts the encrypted financial information included in the image ID by using the unique key value stored in the server 40, so as to provide an interface capable of performing a financial transaction to the user terminal 20.

Accordingly, the embodiment of the present disclosure provides the above-described financial transaction interface to the user terminal 20, and thus financial information may be queried without a complex authentication process, and a remittance transaction service may be provided to the financial account included in the second image ID of the second user. As a result, it may be understood that the above-described financial transaction interface providing part 14 is capable of performing all the functions performed in step S40 in FIG. 1 described above.

That is, by means of organic coupling between each component, the device 10 of providing the financial service through the user authentication based on the image ID including such a configuration stores identification information and user's financial information on an image received from a user terminal to issue an image ID, and uses the image ID issued to the user terminal as an identity authentication means when performing financial transactions, whereby there is an effect of promoting the simplification of the authentication system for financial transactions.

In addition, as the financial information including the user's personal information is encrypted with the unique key value stored only in the server, and then issued and processed as the image ID, the damage caused by the leakage of the user's personal information may be blocked beforehand, the financial information including the user's personal information is inserted and stored in the image ID in an unidentifiable way, and the financial information is encrypted and stored with the unique key value, whereby there is an effect that the users' personal information may be managed and protected at a high security level.

In addition, going further, through image ID authentication, users may be able to easily query their own financial information, as well as easily perform remittance to another user's financial account, whereby there is an effect that the convenience of the mobile financial services is maximally increased.

As described above, although the exemplary embodiments have been described with reference to the limited exemplary embodiments and drawings, various modifications and variations are possible from the above description by those skilled in the art.

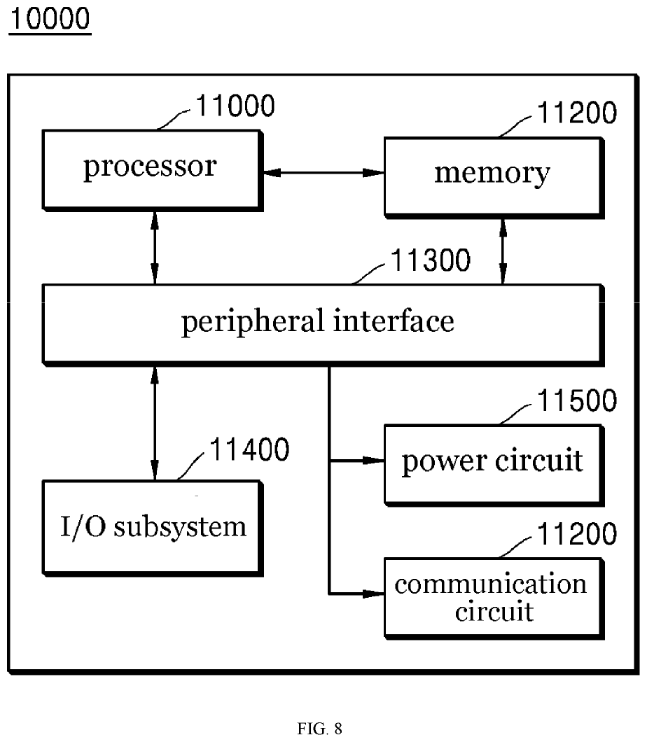

Meanwhile, FIG. 8 illustrates an example of the internal configuration of the computing device according to the exemplary embodiment of the present disclosure, and in the description below, descriptions of unnecessary exemplary embodiments that overlap with the above-described description of FIGS. 1 to 7 will be omitted.

As shown in FIG. 8, a computing device 10000 may include at least one of a processor 11100, a memory 11200, a peripheral interface 11300, an input/output (I/O) subsystem 11400, a power circuit 11500, and a communication circuit 11600. In this case, the computing device 10000 may correspond to a user terminal (A) connected to a tactile interface device or the aforementioned computing device (B).

The memory 11200 may include, for example, a high-speed random access memory, a magnetic disk, SRAM, DRAM, ROM, a flash memory, or a non-volatile memory. The memory 11200 may include a software module, an instruction set, and/or other various data, which are required for the operation of the computing device 10000.

In this case, access to the memory 11200 from other components such as the processor 11100 or the peripheral interface 11300 may be controlled by the processor 11100.

The peripheral interface 11300 may couple input and/or output peripheral devices of the computing device 10000 to the processor 11100 and memory 11200. The processor 11100 may execute the software module or the instruction set, which is stored in the memory 11200, to perform various functions for the computing device 10000 and process data.

The I/O subsystem 11400 may couple various input/output peripheral devices to the peripheral interface 11300. For example, the I/O subsystem 11400 may include a controller for coupling peripheral devices, such as a monitor, a keyboard, a mouse, a printer, or a touch screen or a sensor as needed, to the peripheral interface 11300. According to another aspect, the input/output peripheral devices may be coupled to the peripheral interface 11300 without going through the I/O subsystem 11400.

The power circuit 11500 may supply power to all or some of the components of a terminal. For example, the power circuit 11500 may include a power management system, one or more power sources such as batteries or alternating current (AC) sources, a charging system, a power failure detection circuit, a power converter, an inverter, a power status indicator, and/or any other components for generating, managing, and distributing the power.

The communication circuit 11600 may enable communication with another computing device by using at least one external port.

Alternatively, as described above, when necessary, the communication circuit 11600 may include an RF circuit to transmit and receive an RF signal, also known as an electromagnetic signal, so as to enable communication with other computing devices.

Such an exemplary embodiment of FIG. 8 is only an example of the computing device 10000, and the computing device 10000 may have a configuration or arrangement that omits some components shown in FIG. 8, or further includes an additional component not shown in FIG. 8, or couples two or more components to each other. For example, a computing device for a communication terminal in a mobile environment may further include a touch screen or a sensor in addition to the components shown in FIG. 8, and may include a circuit for RF communication using various communication methods (i.e., Wi-Fi, 3G, LTE, Bluetooth, NFC, ZigBee, etc.) in the communication circuit 11600. Components that may be included in the computing device 10000 may be implemented in hardware, software, or a combination of both hardware and software, the components including an integrated circuit that is specialized for one or more signal processing or applications.

The methods according to the exemplary embodiment of the present disclosure may be implemented in the form of program instructions that may be executed through various computing devices and recorded in a computer-readable recording medium. In particular, the program according to the present exemplary embodiment may be configured as a PC-based program or an application dedicated to mobile terminals. The application to which the embodiment of the present disclosure is applied may be installed in a user terminal through a file provided by a file distribution system. For example, the file distribution system may include a file transmission part (not shown) that transmits the file in response to a request from the user terminal.

The device described above may be implemented as a hardware component, a software component, and/or a combination of the hardware component and the software component. For example, devices and components described in the exemplary embodiments may be implemented by using one or more general purpose computers or special purpose computers, including, for example, a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and one or more software applications running on the operating system. In addition, the processing device may also access, store, manipulate, process, and generate data in response to the execution of the software. Sometimes, there are cases described such that one processing device is used for convenience of understanding, but those skilled in the art will recognize that the processing device may include a plurality of processing elements and/or a plurality of types of processing elements. For example, the processing device may include a plurality of processors, or include one processor and one controller. In addition, other processing configurations with parallel processors, for example, are also possible.

The software may include a computer program, a code, an instruction, or a combination of one or more thereof, and may be configured to enable the processing device to operate as desired or instruct the processing device independently or collectively. In order to be interpreted by the processing device or provide instructions or data to the processing device, software and/or data may be embodied permanently or temporarily in any type of machine, a component, a physical device, virtual equipment, a computer storage medium, or a computer storage device. Software may be distributed over networked computing devices, and stored or executed in a distributed manner. Software and data may be stored in one or more computer-readable recording media.

The method according to the exemplary embodiment may be implemented in the form of program instructions that may be executed through various computer means, and may be recorded in the computer-readable recording media. The computer-readable recording media may include: program instructions, data files, data structures, and the like individually or in combination thereof. The program instructions recorded on the media may be specially designed and configured for the exemplary embodiment, or may be known and available to those skilled in the art of computer software. Examples of the computer-readable recording media include: magnetic media such as hard disks, floppy disks, and magnetic tapes; optical media such as CD-ROMs and DVDs; magneto-optical media such as floptical disks; and a hardware device specially configured to store and execute program instructions, the hardware device including such as ROM, RAM, flash memory, etc. Examples of program instructions include not only machine language codes such as those generated by a compiler, but also high-level language codes that may be executed by a computer using an interpreter or the like. The hardware device described above may be configured to operate by one or more software modules to perform the operations of the exemplary embodiments, and vice versa.

As described above, although the exemplary embodiments have been described with reference to the limited exemplary embodiments and drawings, various modifications and variations are possible from the above description by those skilled in the art. For example, appropriate results may be achieved even when the described techniques are performed in a different order rather than that of the described method, and/or even when the described components of the system, structure, device, circuit, and the like are coupled to each other or combined in a different form rather than that of the described method, or replaced or substituted by other elements or equivalents. Therefore, other implementation, other exemplary embodiments, and equivalents to the patent claims also fall within the scope of the following patent claims.

1. A method for providing a financial service through user authentication based on an image ID, the method being implemented in a computing device configured to comprise one or more processors and one or more memories to store instructions executable by the processors, and comprising;
marking identification information, wherein an image to be used as an identity authentication means is received when the financial service is used from a user terminal, and the marking of the identification information for identifying that the received image is the image ID is performed on one area of the received image by using an application programming interface (API) linked for the marking of the identification information;
storing an encryption means, wherein user's financial information that is input from the user terminal is encrypted and stored on the received image, a unique key value generated by a server is used as an encryption processing means, and the encrypted financial information and the unique key value used as the encryption means are stored in the server;
issuing and processing the image ID, wherein the image comprising the identification information and the encrypted financial information is provided to the user terminal, so as to issue and process the image ID of a user; and
providing a financial interface, wherein financial information included in the image ID selected as a financial transaction target in the user terminal is decrypted with the unique key value after an execution command of an application related to financial service provision is received from the user terminal, so as to provide a financial transaction interface corresponding to the decrypted financial information to the user terminal.

2. The method of claim 1, wherein, when performing the providing of the financial interface, the server performs verification of the identification information marked on the image ID selected and input in the user terminal, so as to determine whether to grant access to the financial information included in the image ID.

3. The method of claim 1, wherein the unique key value is automatically generated from the server as a value to comprise at least any one of a special character, a number, and letter, and is used as a means for authenticating and identifying one or more image IDs by allowing different unique key values to be assigned to the respective image IDs.

4. The method of claim 1, wherein, after performing the issuing and processing of the image ID, in the server, the image ID issued to the user terminal and the unique key value used for the image ID are stored and managed in correspondence with each other.

5. The method of claim 1, wherein the financial information is inserted and stored in the one area of the image, and is inserted and stored in a form identifiable only by a preset processor configured to extract the financial information from the image by controlling the encrypted financial information and format information comprising at least any one of a size, transparency, and a color of the unique key value.

6. The method of claim 1, wherein the financial information is inserted and stored in the one area of the image, and is inserted and stored in a form of link information capable of receiving the encrypted financial information and the unique key value in the one area of the image.

7. The method of claim 1, wherein information comprising at least any one of the user's financial information and the unique key value is cached in a file constituting the image, and
the information comprising at least any one of the user's financial information and the unique key value is stored in a form of a data stream in the file constituting the image.

8. The method of claim 1, wherein the financial transaction interface provides a query service for financial information stored in a first image ID when the first image ID that is the image ID issued to the user terminal is selected from the user terminal, and provides a remittance service for financial information stored in a second image ID when the second image ID issued to a second user terminal is selected from the user terminal.

9. The method of claim 8, wherein, when the second image ID is selected through the financial transaction interface in the user terminal, the financial information decrypted from the second image ID to the user terminal is financial information on a depositor name, a bank name, and an account number.

10. The method of claim 1, wherein, after performing the issuing and processing of the image ID, the user terminal is provided with the financial transaction interface corresponding to the image ID when there is selection and input for the image issued and processed as the image ID of the user from the user terminal.

11. A device for providing a financial service through user authentication based on an image ID, the device being implemented in a computing device configured to comprise one or more processors and one or more memories to store instructions executable by the processors, and comprising;
an identification information marking part, wherein an image to be used as an identity authentication means is received when the financial service is used from a user terminal, and marking of identification information for identifying that the received image is the image ID is performed on one area of the received image by using an application programming interface (API) linked for the marking of the identification information;
an encryption means storing part, wherein user's financial information that is input from the user terminal is encrypted and stored on the received image, a unique key value generated by a server is used as an encryption processing means, and the encrypted financial information and the unique key value used as the encryption means are stored in the server;
an image ID issuing and processing part, wherein the image comprising the identification information and the encrypted financial information is provided to the user terminal, so as to issue and process the image ID of a user; and
a financial interface providing part, wherein financial information included in the image ID selected as a financial transaction target in the user terminal is decrypted with the unique key value after an execution command of an application related to financial service provision is received from the user terminal, so as to provide a financial transaction interface corresponding to the decrypted financial information to the user terminal.

12. A computer-readable recording medium, comprising:
a plurality of instructions stored therein and configured to allow a computing device to perform steps as below,
wherein the steps comprise:
marking identification information, wherein an image to be used as an identity authentication means is received when the financial service is used from a user terminal, and the marking of the identification information for identifying that the received image is the image ID is performed on one area of the received image by using an application programming interface (API) linked for the marking of the identification information;
storing an encryption means, wherein a user's financial information that is input from the user terminal is encrypted and stored on the received image, a unique key value generated by a server is used as an encryption processing means, and the encrypted financial information and the unique key value used as the encryption means are stored in the server;
issuing and processing the image ID, wherein the image comprising the identification information and the encrypted financial information is provided to the user terminal, so as to issue and process the image ID of a user; and
providing a financial interface, wherein financial information included in the image ID selected as a financial transaction target in the user terminal is decrypted with the unique key value after an execution command of an application related to financial service provision is received from the user terminal, so as to provide a financial transaction interface corresponding to the decrypted financial information to the user terminal.
